(19) United States
(12) Patent Application Publication
(10) Pub. No.: US 2006/0204667 A1
(43) Pub. Date: Sep. 14, 2006

(54) Method and apparatus for coloring concrete

(76) Inventor: Charles Kreutzer, Springfield, IL (US)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 11/352,508

(22) Filed: Feb. 10, 2006

Related U.S. Application Data
(60) Provisional application No. 60/651,565, filed on Feb. 10, 2005.

(51) Int. Cl. B05D 7/00; B28B 19/00; B05C 5/00

(52) U.S. Cl. 427/421.1; 118/300

(57) ABSTRACT

The present invention relates to a method and an apparatus for diluting a liquid colorant. The method and apparatus are especially suitable for use in conjunction with the manufacture of colored concrete products. The method of spraying includes, providing a liquid colorant, diluting the liquid colorant with a diluting liquid, and spraying the diluted liquid colorant onto uncured concrete and/or on mold surfaces prior to filling with uncured concrete. The apparatus for spraying a diluted liquid colorant includes a flow path for a diluting liquid, a liquid colorant pump connected to the flow path, a mixer for mixing the diluting liquid with the liquid colorant, and a sprayer connected to the flow path.

This Application claims the benefit of U.S. Provisional Patent Application No. 60/651,565 filed Feb. 10, 2005.

### FIELD OF THE INVENTION

The present invention relates to a method and apparatus for coloring uncured concrete, including a method and an apparatus for diluting a liquid colorant prior to its application to uncured concrete.

### DESCRIPTION OF RELATED ART

Many processes and techniques have been tried to efficiently and successfully add “color” to concrete. One attempt included mixing carbon black and water together and then manually adding this solution onto division plates of a mold for concrete blocks. The carbon black solution provided a “flashing” appearance on the surface of the concrete block. Unfortunately, this method did not provide for a durable product, as the color would wear off the concrete block from exposure to weather. A similar method to color concrete included preparing a colorant of a solution of water, cement and synthetic iron oxide black. The colorant was also applied to the division plates. Cement was added to the solution as a bonding agent to create better adhesion between the colorant and the concrete product. However, this process does not lend itself to automation.

Another method to color concrete involves spraying a mold for a concrete block with a colorant. The mold would then impart a colored appearance to the concrete block.

Another method to color concrete involves sifting dry colorants onto uncured concrete. However, this process was difficult to automate. Further, the end product suffered from poor bonding and adhesion.

Other attempts involved a dry mixing of colorant, sand and cement (with or without a wetting aid). This dry mixture would then be sprinkled on the mold surface. However, the end product sometimes suffered from poor bonding and adhesion. This process is also difficult to automate.

Other attempts involved batching different colored mixes of concrete and mixing the colored concrete to form a blended final product. This method requires a complex system of hoppers and belts to blend the material.

Another method to color concrete involved adding a liquid colorant during a mixing stage of the concrete preparation process. Liquid colorants, such as CF920AC available from Solomon Colors, Inc., containing an acrylic bonding aid exhibit satisfactory bonding characteristics; however, these liquid colorants exhibit unsatisfactory mixing characteristics, as it is sometimes difficult to evenly transfer the liquid colorant throughout the uncured concrete. The uncured concrete and liquid colorants often require mechanical mixing to distribute the liquid colorant throughout the uncured concrete, thus increasing production costs and requiring additional equipment and steps. Further, the liquid colorants with the acrylic binders tended to “ball-up” when sprayed on the uncured concrete forming highly concentrated pockets or regions of “balls” of the liquid colorant. Other liquid colorants, using urethanes and epoxy as binders, are also prone to “balling-up” and likewise often require mechanical mixing.

### SUMMARY OF THE INVENTION

Embodiments, including the technical features of the invention for which protection is sought, are illustrated and described herein and include a method and an apparatus for diluting a liquid colorant and spraying the diluted liquid colorant onto uncured concrete. The apparatus mixes the liquid colorant with a diluting liquid immediately prior to spraying the diluted liquid colorant onto the uncured concrete. By diluting the liquid colorant, transfer characteristics of the liquid colorant to the uncured concrete are improved.

It is an aspect of the present invention to provide an apparatus and method for “inline blending,” i.e., the liquid colorant is blended or diluted as it is being used by the spray system.

It is an aspect of the present invention to provide a method of coloring concrete that reduces the amount of the liquid colorant necessary to obtain the desired color of the concrete.

It is another aspect of the present invention to provide a method of coloring concrete that does not require mechanical mixing of the liquid colorant and the uncured concrete.

It is another aspect of the present invention to provide a method and apparatus to modify the cohesiveness properties of the liquid colorant.

It is an aspect of the present invention to provide a method of improving the transfer characteristics of the liquid colorant.

By this invention, these and other aspects are achieved.

### BRIEF DESCRIPTION OF DRAWINGS

FIG. 1 is flow chart showing the operation of the present invention.

FIG. 2 is a block diagram showing an embodiment of the present invention.

FIG. 3 is a rear view of the embodiment.

FIG. 4 is a left-rear view of the embodiment.

FIG. 5 is a left view of the embodiment.

FIG. 6 is a front view of the embodiment focusing on the water pump.

FIG. 7 is a front view of the embodiment focusing on the two surge tanks.

FIG. 8 is a front view of the embodiment showing the surge tanks and the pigment tank.

FIG. 9 is view of the embodiment focusing on the water pump.

FIG. 10 is a right view of the embodiment.

FIG. 11 is another right view of the embodiment.

FIG. 12 is a lower front-right view of the embodiment focusing on the colorant tank.

FIG. 13 is a lower front-left view of the embodiment.

FIG. 14 is a printout from the screen of the control panel.

FIG. 15 is another printout from the screen of the control panel.

### DETAILED DESCRIPTION OF PREFERRED EMBODIMENTS

The present invention relates to a method and an apparatus for diluting a liquid colorant and spraying the diluted liquid colorant onto uncured concrete. The method and apparatus are especially suitable for use in conjunction with the manufacture of multicolored concrete products. The present invention improves existing processes for applying the liquid colorant to uncured concrete. By diluting the liquid colorant, transfer characteristics of the liquid colorant to the uncured concrete are improved. The apparatus mixes the liquid colorant with a diluting liquid immediately prior to spraying the diluted liquid colorant onto the uncured concrete. The spraying of the diluted liquid colorant may occur at many stages of the processing of the uncured concrete, such as, for example, the stages described herein. The method and apparatus may be used in the manufacture or production of a variety of concrete products, such as, for example, concrete blocks, split face arch blocks, retaining wall units, artificial cast stone, to create surface flashing on dry cast block, concrete roof tiles, and other concrete products.

The process for forming multicolored concrete blocks generally includes first mixing cement, aggregate, sand, and water in a mixer to form the uncured concrete. From the mixer, the uncured concrete is transferred to a hopper which acts a vessel to hold the uncured concrete. The hopper then empties the uncured concrete onto a belt which transfers the uncured concrete to a molding machine. If it is desired to make a colored concrete product, the uncured concrete may be sprayed with the liquid colorant at several points in the concrete block forming process.

A preferred point to spray the uncured concrete is while the uncured concrete is on the belt, since the movement of the belt past the sprayer allows the concrete to be evenly coated. As the belt empties onto the mold, some mixing and transferring of the liquid colorant and the concrete occurs. This mixing and transferring may sufficiently transfer the liquid colorant to the uncured concrete. No additional mechanical mixing is required. Unlike many prior art processes that require complex mechanical mixing tools and apparatus, the liquid colorant after being diluted by the present invention, may be sprayed onto the uncured concrete and satisfactorily transferred to the uncured concrete. In order to receive or obtain more variation in the finished product, simple passive plows may be employed on the belt after the spray.

Typically, the liquid colorant for concrete applications is in an aqueous solution comprising pigments, dispersants, suspension agents, binders, and water. A suitable colorant for use with this invention is CF920AC, commercially available from Solomon Colors, Inc. The pigments in the colorant, such as mineral oxides like iron oxides, cobalt oxides, chromium oxides, and copper oxides provide the appearance of color to the aqueous solution. The dispersants allow deglomeration and wetting of the pigment for the aqueous solution. The suspension agents maintain the pigments in the homogenous aqueous solution, i.e., the suspension agents, prevent the pigments from falling out of the aqueous solution. Without the suspension agents, the liquid colorant would require constant agitation. The binders assist the pigments in binding to the concrete. Suitable binders include, but are not limited to, acrylic, urethane, and epoxy binders.

The dilution method of the present invention overcomes the cohesive properties and action of the binder and the suspension agent and improves the adhesion characteristics of the liquid colorant to the uncured concrete. The addition of the water affects the cohesive properties of the liquid colorant; however, importantly, the diluting method is employed immediately prior to the spraying of the liquid colorant onto the uncured concrete, to reduce the likelihood that the pigments could fall out of the solution. The apparatus of the present invention provides for the dilution of the liquid colorant immediately prior to its application on the concrete. The apparatus of the present invention provides for adhesion of the liquid colorant to the uncured concrete without mechanical mixing.

By dilution of the liquid colorant immediately prior to its application to the uncured concrete, a more concentrated liquid colorant may be shipped to the end user thus reducing shipping and storage costs. In the typical formulation of the liquid colorant that is required to maintain a homogenous solution, the binder, and the suspension agents cause the liquid colorant to “ball” when the liquid colorant is applied to the uncured concrete. The “balling” wastes liquid colorant since it can create localized concentrated regions or pockets of liquid colorant. Unfortunately, the suspension agent is necessary to maintain the liquid colorant in a homogenous solution. However, by preventing the “balling” of the liquid colorant, less liquid colorant is required to obtain the desired color effect on the concrete. Since less liquid colorant is used, the cost of the raw materials for the colored concrete blocks is reduced.

The method and the apparatus of the present invention dilutes the liquid colorant to approximately 1.5 percent by weight of solids to approximately 40 percent by weight of solids. Of course, dilution rate will vary depending on the application.

The method and apparatus of the present invention is well adapted to be used in the colored concrete block industry, such as those blocks used in landscaping and retaining walls. Of course, the methods and apparatus described herein may be used in nearly all concrete applications.

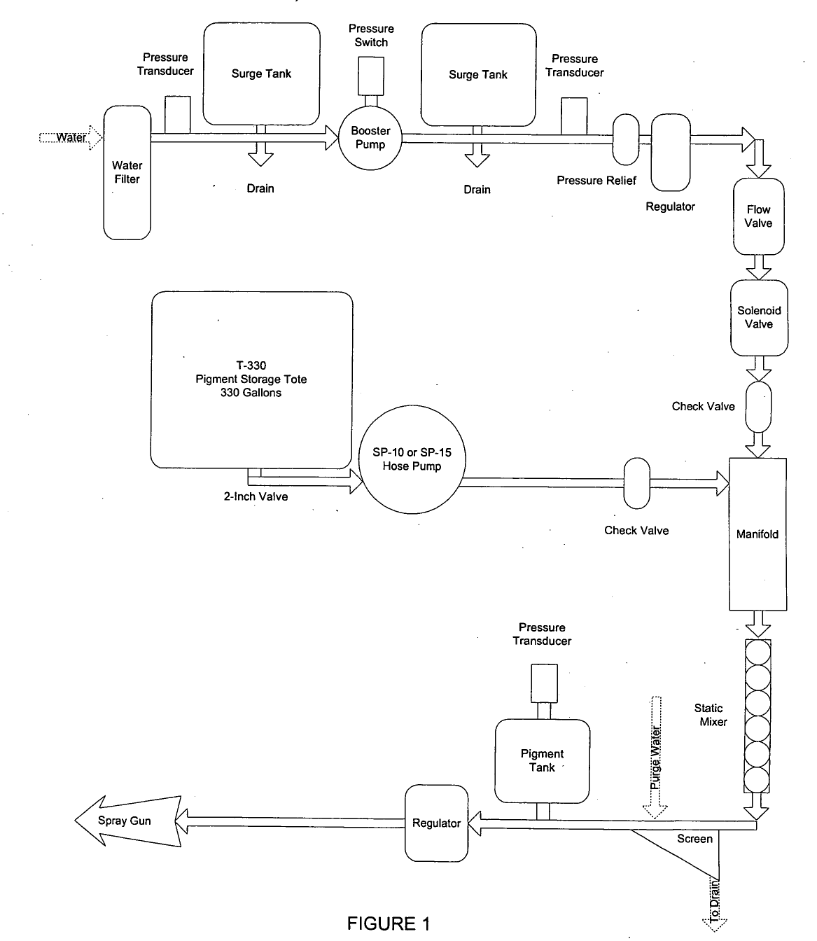

The apparatus of the present invention generally includes a mixer, a liquid colorant pump, and a supply of water. A variety of regulators and flow pressure sensors are used to monitor and adjust the flow of the various liquids. A flow chart for one embodiment of the present invention is shown in FIG. 1. The apparatus allows the liquid colorant to mix with a diluting liquid, such as water, to dilute the liquid colorant immediately prior to its application via a spray system to the uncured concrete. As mentioned above, the diluted liquid colorant needs to be sprayed onto the uncured concrete immediately after its dilution, or the pigments in the diluted liquid colorant may fall out of solution.

In a first embodiment, water enters a flow path, such as a pipe, tube, or hose, and encounters a bypass and a water pump. The water pump and the bypass cooperate with pressure regulators to deliver the desired flow of water in the flow path. A colorant metering pump pumps the liquid color into the flow path where it mixes with the water. A preferred mixing device comprises a static mixer. Static mixers are a pipe that has a passive mixing device, such as baffles. The turbulence created by the liquids passing over the baffles mixes the liquids.

After the liquid color is diluted by the water, the diluted liquid color may pass directly to a spray head. The color metering pump may open simultaneously with the spray head. Flow rates may be matched to the end production rate. Spray tips may be used on the spray head with different drill sizes to achieve different flow rates. Tip flow rates are also impacted by the delivery pressure.

In a second embodiment, the water and the regulator may be replaced with a diaphragm pump with a regulator. The diaphragm pump will provide water at a constant pressure.

The present invention provides an apparatus for diluting the liquid colorant immediately before spraying the liquid colorant onto the uncured concrete. If the liquid colorant is diluted too far ahead of time, then the pigments may fall out of the solution. The present invention provides a diluted solution of liquid colorant on demand without concern for settling or continuous agitation.

The present invention includes systems and components to accommodate fluctuations in the flow of the incoming water supply. As will be readily understood by one of ordinary skill in the art, water supply may fluctuate depending on plumbing systems, use by other systems in the environment of the spray system, and local uses in the water supply region. In one embodiment of the present invention, one or more surge tanks are used to accommodate these fluctuations.

In a preferred embodiment, two surge tanks are employed. A first surge tank holds a supply of water. The first surge tank receives the water from the water supply. A second surge tank receives the water from a pump at a desired pressure, and delivers the water to the spray system. The second surge tank includes a bladder to pressurize the water.

An important feature of the present invention is the ability of the present invention to be adjusted by the user. Depending on the application of the spray system, the user may prefer to input a specific delivery pressure, a start/stop sequence, and a dilution ratio. The present invention provides a “user-adjustable” spray system that may be adjusted in the field to a specific application by inputting desired parameters into a microprocessor of the spray system. These parameters of the spray system may further be adjusted between applications. This feature is important in making an economical commercial system, as it would not be feasible to provide a customized spray system to each user.

Some of the parameters that may be inputted and user-adjusted include:

The delivery pressure, which refers to the pressure of the diluted liquid colorant leaving the spray system. Typically delivery pressures are approximately 20 PSI to approximately 50 PSI.

The start/stop sequence, which refers to the timing of the activation of the spray systems. The spray system may be programmed to spray the diluted liquid colorant at precise timed intervals or when uncured concrete is detected by the spray system.

The dilution ratio, which refers to the volume of liquid colorant diluted by the volume of water. Typical dilution ratios are approximately 1 part liquid colorant to a range of approximately 1 part water to approximately 40 parts water.

In one preferred embodiment, the spray system includes a touch screen microprocessor that receives input from the user as to the delivery pressure, the start/stop sequence, and the dilution ratio. Of course, the microprocessor is used to monitor and adjust other features and components of the spray system. A suitable touch screen microprocessor is commercially available from General Electric. A windows based operating system may be used with the microprocessor.

The present invention provides an apparatus and method of “inline blending,” i.e., the liquid colorant is blended or diluted as it is being used.

The spray system may be used in conjunction with totes of liquid colorant, such as, for example, a T330 or T400 tote of liquid colorant commercially available from Solomon Colors, Inc.

The spray system may be employed in different manners depending on the spraying application. If the spray system is used in conjunction with a moving belt loaded with concrete material, then the spray system may be mounted adjacent with the belt and timed, either electronically or mechanically, to spray as the concrete material moves by. This method of use of the spray system may be used with integral concrete products, such as split face arch block and retaining wall units. By spraying the concrete product on the belt, mechanical mixing to transfer the liquid colorant is not required. If the spray system is used with molding equipment, then the spray system may be electronically timed to, in rapid bursts, spray the empty mold before a concrete material is loaded into the mold. This may be used for the product of wet cast concrete products. This method may also be used to create surface flashing on dry cast block. For the production of dry cast concrete products, the division plates of the molding apparatus may be sprayed with the diluted liquid colorant.

The spray system may also be manually activated via a trigger. The spray system and method of the present invention may be used in the artificial cast stone industry. For example, the uncured concrete may be sprayed as the uncured concrete enters the mold for the artificial cast stone or in the mold itself prior to filling with uncured concrete.

The spray system may also be used in the manufacture of concrete roof tiles. The spray system may spray into the wet concrete mix just prior to extrusion. Pulsing the spray on and off through multiple spray heads will give a random flashed appearance to the extruded tile.

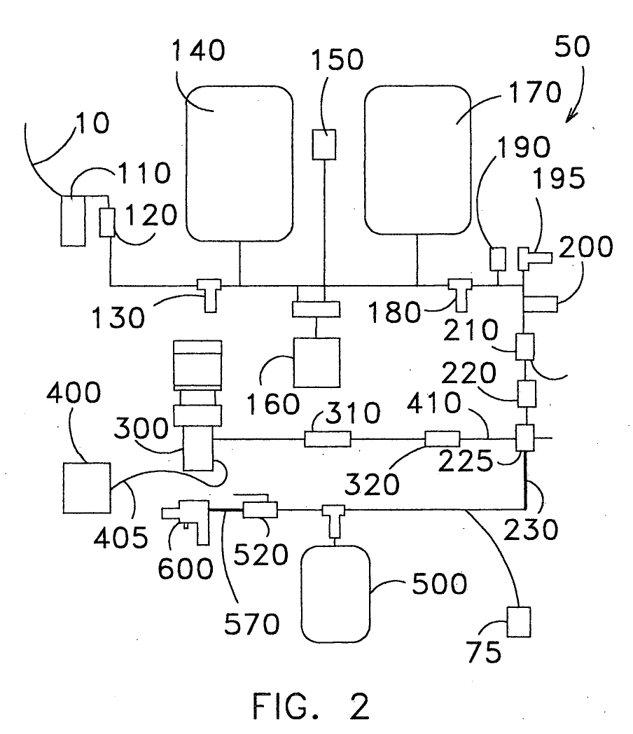

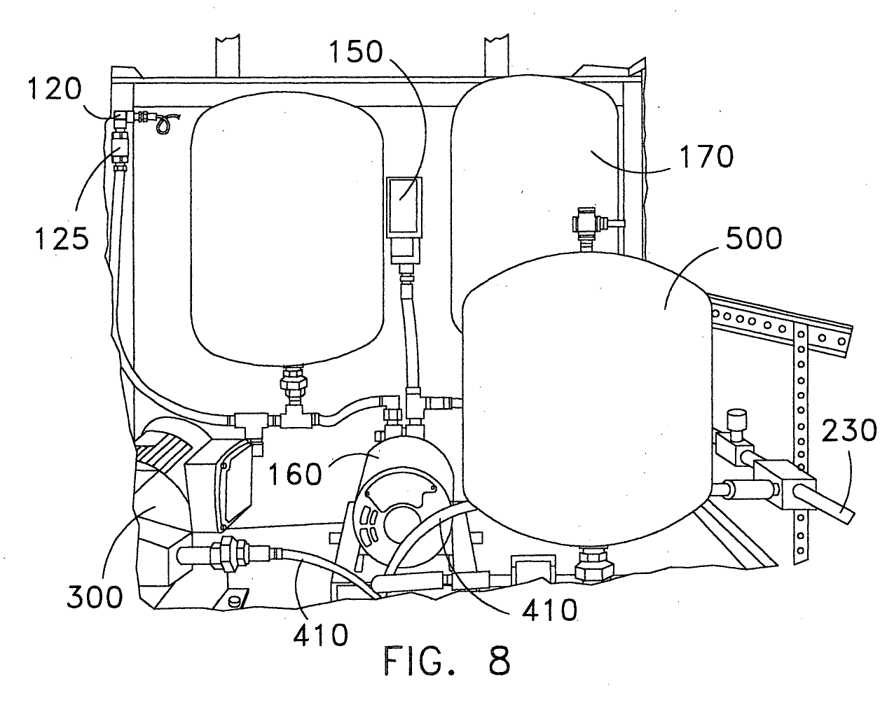

The present invention will now be described with respect to an embodiment shown in FIGS. 2-13. A block diagram showing an overall layout of a spray system 50 is shown in FIG. 2.

The spray system 50 will now be described in a sequential manner, generally following the fluids in the flow path of the spray system 50.

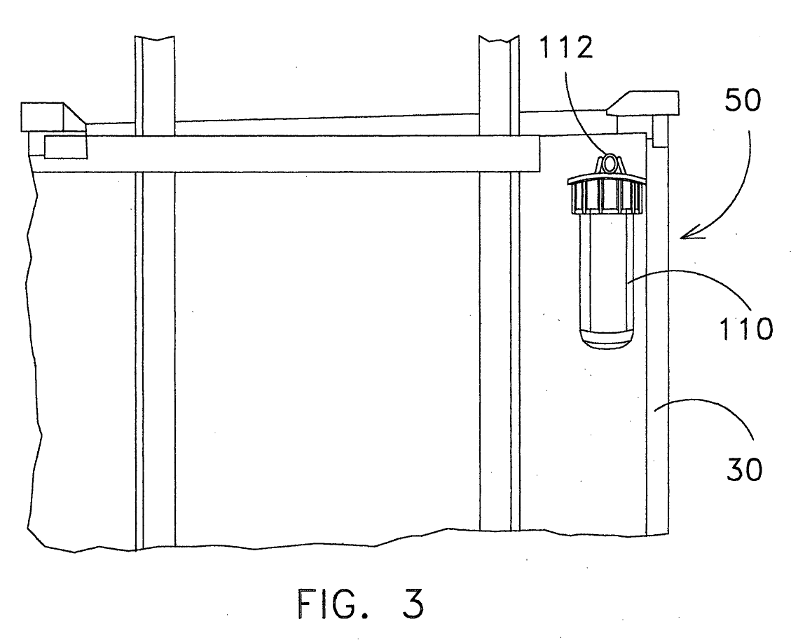

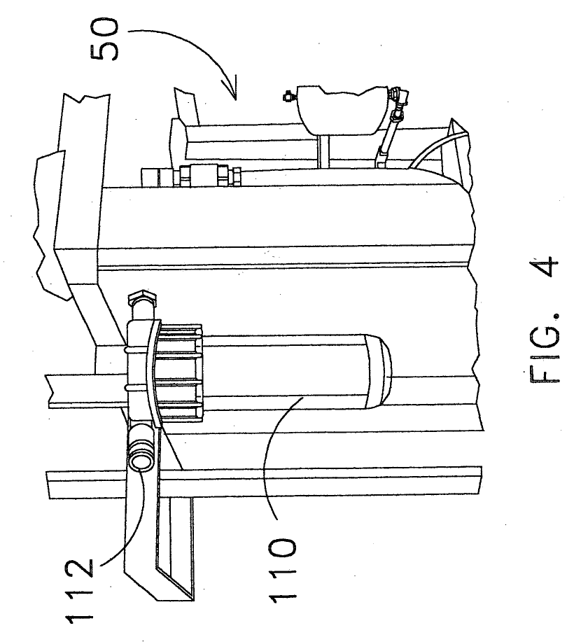

FIG. 3 is a rear view of the spray system 50. FIG. 4 is a left-rear view of the spray system 50. A tote base 30 provides a housing to hold the spray system 50. The tote base 30 is made of rigid and strong material, such as steel. It can safely hold and receive a tote containing hundreds of gallons of liquid colorant.

Water enters the spray system 50 from a water supply 10. The water supply 10 may include a municipal water supply, large supply tanks, etc. The incoming water is first filtered at filter 110 to remove particulate matter. The water supply 10 connects to the filter 110 via a connection 112.

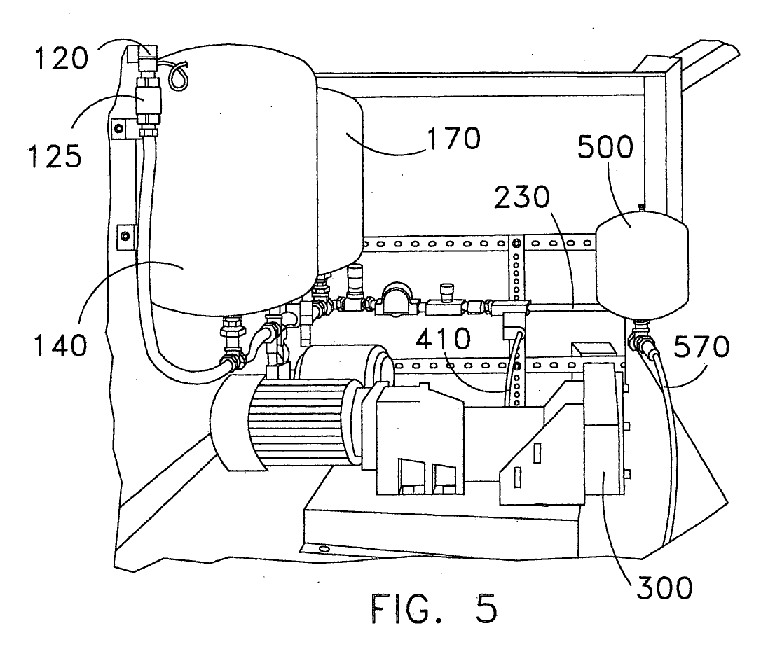

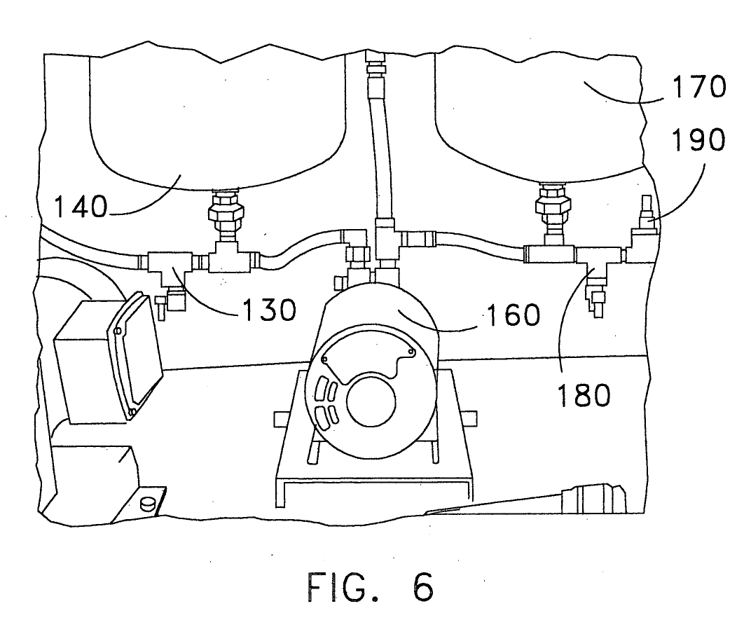

Turning to FIG. 5, the water passes through a pressure transducer 120 and a check valve 125. The pressure transducer 120 converts the pressure of the incoming water into an electrical signal received by a control panel 75. The control panel 75 is also in electrical communication with the other components and features of the spray system 50. The control panel 75 includes a microprocessor. With specific reference to FIG. 6, the water supply next passes through a valve 130. The valve 130 may be used to drain its region of the spray system 50.

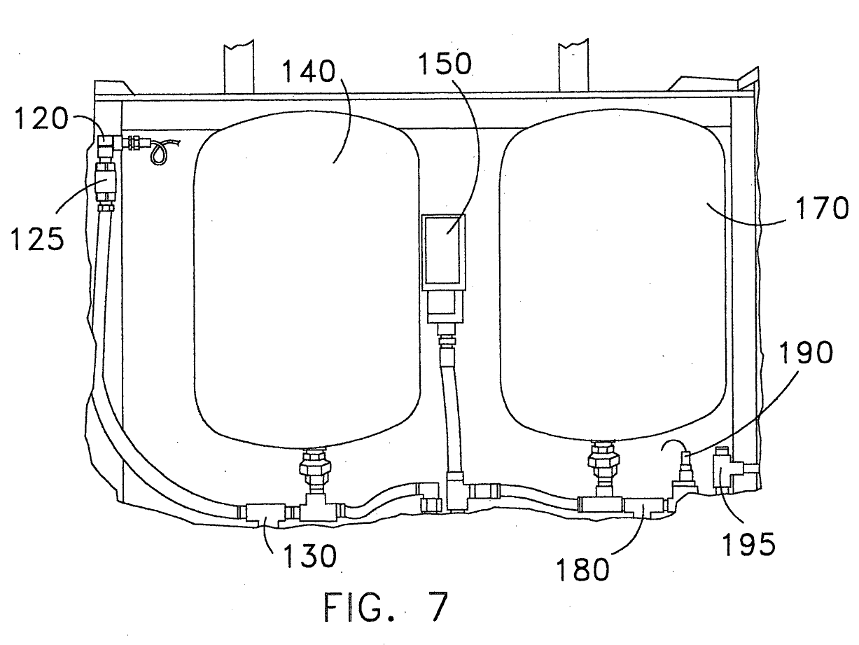

As shown in FIG. 7, the water next enters a first water surge tank 140 that provides a reservoir for the spray system 50. A second water surge tank 170 maintains the water at the pressure required by the spray system 50.

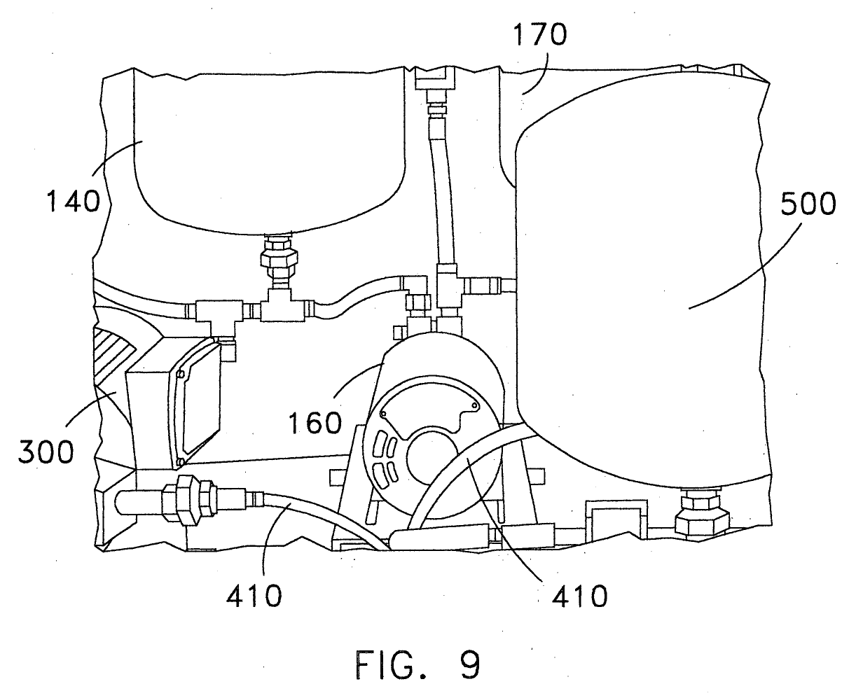

A water pump 160, shown in FIGS. 6 and 9 among others, acts as a booster pump and transfers water to the second surge tank 170, depending on the readings of a pressure switch 150 shown in FIG. 7. With reference to FIG. 6, a valve 180 assists in draining its region of the spray system 50.

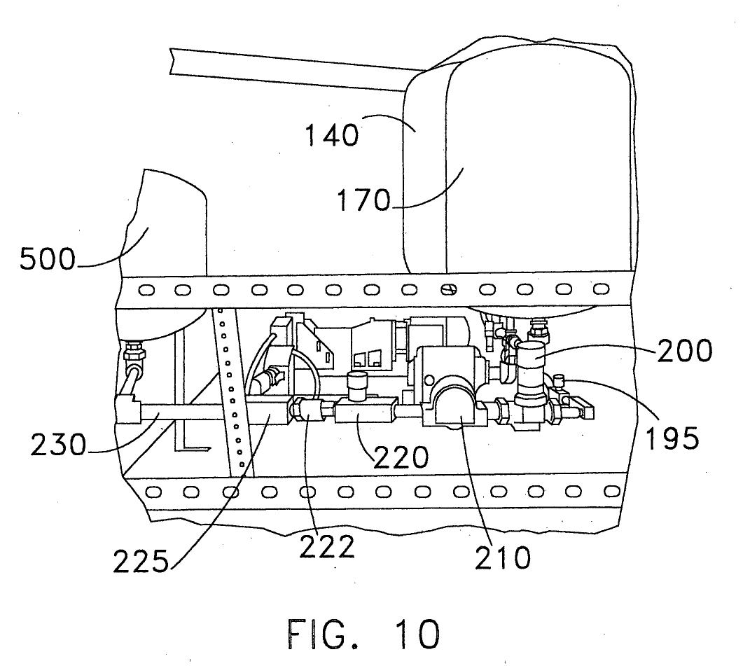

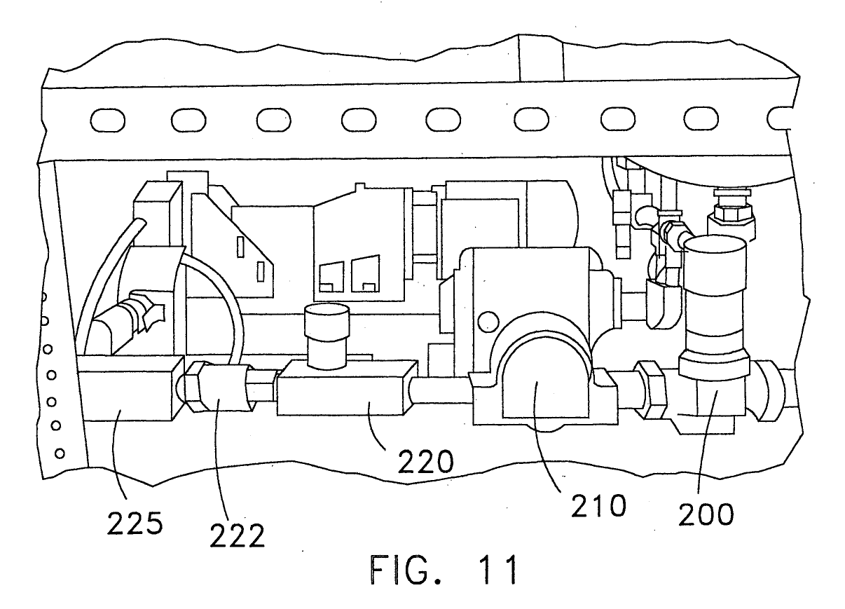

Turning now to FIG. 7, a pressure transducer 190 measures the pressure of the water in the spray system 50 as the water leaves the second surge tank 170. Turning now to FIGS. 10 and 11, a pressure relief valve 195 may let off pressure from the spray system 50. Pressure regulator 200 adjusts the pressure of the water in the spray system 50. A flow sensor 210 measures the flow of the water in the spray system 50. A flow control 220 may be used to adjust the flow of the water through the spray system 50. A solenoid valve is one suitable type of flow control. The solenoid valve may start and stop the flow of water. A check valve 222 controls flow of the water. The pressure regulator 200 in conjunction with the flow control 220 gives constant flow at constant pressure, i.e. one gallon per minute.

A manifold 225 receives both the water and the liquid colorant. The manifold connects to an inline mixer 230. The inline mixer 230 mixes the water and the liquid colorant. Then, a pigment tank 500 holds the diluted colorant prior to being sprayed by a sprayer 600. The manifold 225 may also be used to input chemical admixtures into the flow path. The chemical admixtures may be used to improve the processing of the concrete products.

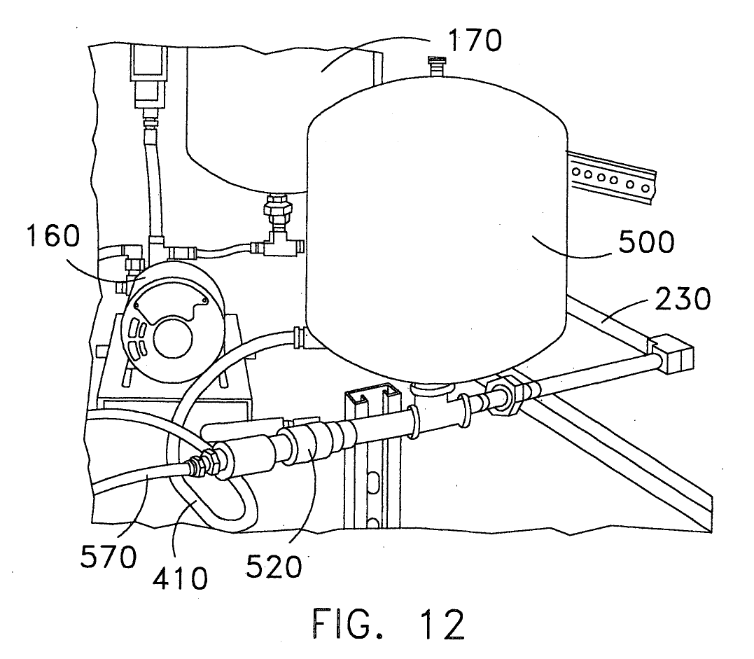

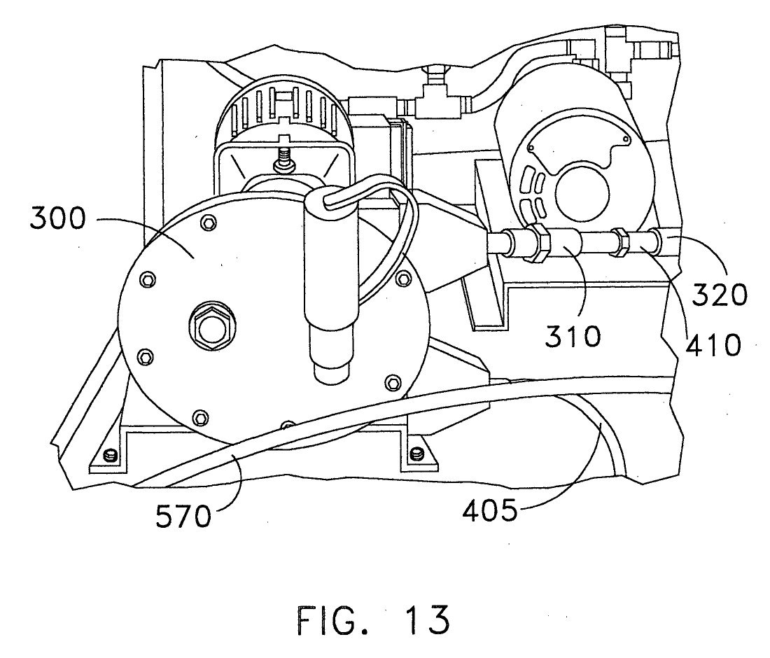

Turning now to FIGS. 12 and 13, a colorant pump 300 receives the liquid colorant from a colorant reservoir 400 or other colorant supply via a hose 405. The colorant pump 300 then pumps the colorant from the colorant reservoir 400 via a colorant hose 410 through a check valve 310 and flow sensor 320 and before the liquid colorant reaches the manifold 225. The speed of the colorant pump may be adjusted to dilute the liquid colorant at a desired rate to achieve the dilution ratio selected.

After leaving the inline mixer 230, the diluted colorant passes to the pigment tank 500. A drain valve and an entry valve for a purging fluid may be included after the inline mixer 230 and before the pigment tank 500. The drain valve may be connected to a screen and a drain. The purging fluid may be used to clean this region of the spray system 50.

From the pigment tank 500, the diluted colorant flows through a regulator 520 and a spray hose 570 to the spray gun 600.

In this embodiment, the following components and parts provided satisfactory performance: The water filter 110 is a Model PF30 manufactured by the True Blue Company. The first water surge tank 140 and the second water surge tank 170 are Model 44P833A commercially available from the Teal Company. The pressure transducers 125 and 190 are MSP300 100P5N1 from Measurements Specialties. The Pressure switch 150 is a square “D” GNG-5 pressure switch. The water pump 160 is a Model 6K160E Carbonator Pump Motor from the Dayton Company.

The pressure regulator 200 is a Honeywell D505. The flow sensor 210 is a Flow Stat model available from Lake Monitors Manufacturing. The inline mixer 230 is a Rono Static Inline Miner ½-40-2-12-2. The colorant pump 300 is a SP10 or SP15 pump from Watson Marlow. The colorant reservoir 400 is a T-330 from Solomon Colors, Inc. The pigment tank 500 may be a Teal Model 3P676C. The spray gun 600 may be an air-atomizing spray gun commercially available from Spray Systems, Inc. as Part Number AA10000A414-10.

In other embodiment of this invention, dispersants are introduced into the spray system 50. The dispersants are mixed with the diluted colorant. The dispersants may be introduced at many points in the spray system. It is preferred to add the dispersants at the manifold 225. The dispersants may also be added to the concentrated pigment by the color manufacturer.

In one embodiment of the present invention, a flow valve (for example, the flow valve 210 and a regulator (for example, the regulator 200) are used to provide a constant water flow. The speed of a colorant pump (for example, the colorant pump 300) is adjustable to provide the appropriate dilution. In this embodiment, the constant water flow, coupled with the adjustment of the speed of the colorant pump, provides a known dilution rate. In this embodiment, the spray system cycles “on” and “off” for delivery of small batches to a pigment tank almost on a continuous basis. This embodiment provides a simpler programming of the spray system.

In another embodiment of the present invention, the spray system includes components and systems to provide one or more different liquid colorants. The spray system may be connected to or contain one or more different liquid colorants. The spray control system may include one or more nozzle assemblies for spraying the different liquid colorants.

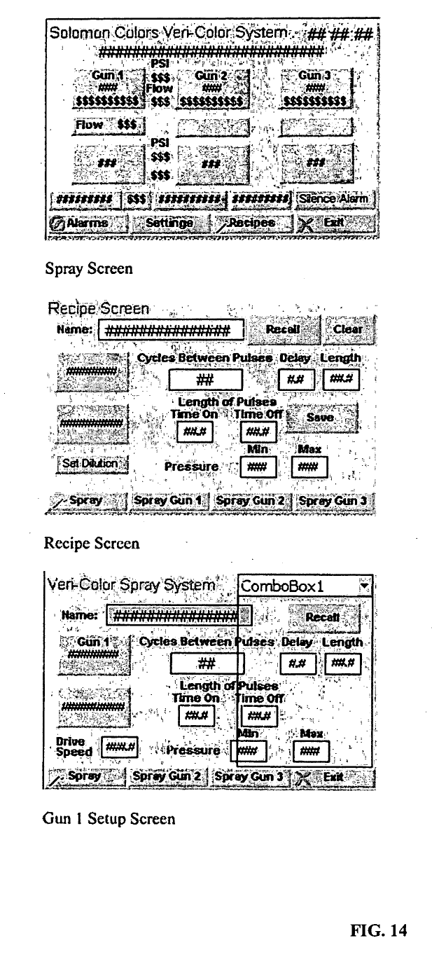

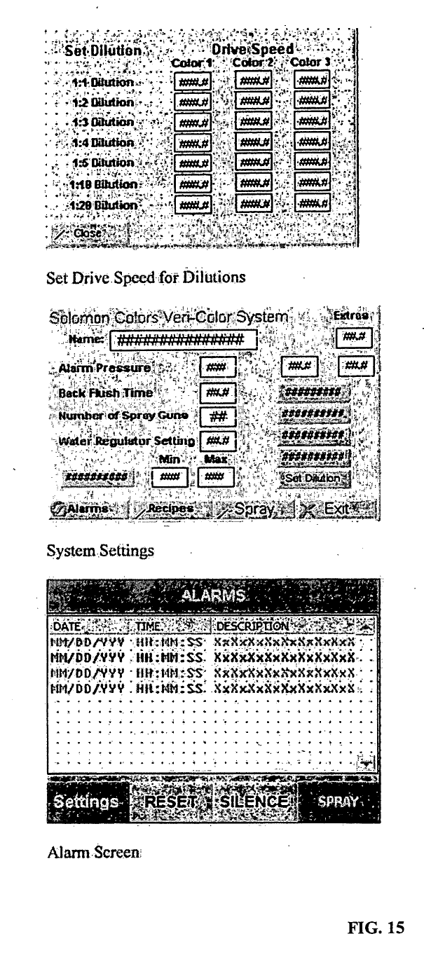

FIGS. 14 and 15 show printouts from a screen of the control panel 75. The screen may be used to input and display operating parameters and current operating conditions, such as, for example, flow and pressure. In this embodiment, the spray system is set up to operate with three colors. Each spray gun may be adjusted with different operating parameters.

“Drive speed” refers to the speed of the colorant pump. The drive speed may be adjusted to provide different dilutions. The water regulator provides a constant water flow to be mixed with the liquid colorant.

The “delay” refers to how much delay is desired between pulses. The “length” refers to the duration of the pulse. The “cycles between pulses” provide for a desired number of cycles to occur between pulses. These parameters, for example, allow the user to create products with different shadings.

An alarm feature may be activated to monitor pressures and provide signals if certain pressures are observed. The alarm may provide a time and description of the observation of the certain pressures.

As described herein, the liquid colorant is diluted immediately prior to being sprayed onto uncured concrete or into the mold. This is accomplished by diluting mini batches of liquid colorant, which are stored in the pigment tank for immediate delivery to the sprayer. The spray system preferably sprays the diluted liquid colorant within seconds of its dilution. The pigment tank is not intended to store the diluted liquid colorant for longer than a few minutes. If the diluted liquid colorant is not immediately sprayed from the pigment tank, then the pigment may fall out of suspension.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the present invention.

1. A method of spraying a liquid colorant on uncured concrete, comprising:
providing a liquid colorant into a flow path;
providing a diluting liquid into the flow path;
providing a mixer connected to the flow path;
diluting the liquid colorant with the diluting liquid in the mixer;
providing a sprayer connected to the flow path; and
spraying the diluted liquid colorant onto the uncured concrete.

2. The method of spraying a liquid colorant according to claim 1, further comprising spraying the uncured concrete while the uncured concrete is on a conveyor belt or on other transfer means.

3. The method of spraying a liquid colorant according to claim 1, wherein the diluting of the liquid colorant occurs immediately prior to its application to the uncured concrete.

4. The method of spraying a liquid colorant according to claim 1, wherein the diluting liquid is water received from a water supply, the method further comprising accommodating fluctuations in a flow of the water from the water supply.

5. The method of spraying a liquid colorant according to claim 1, wherein the spraying further comprises inline blending of the liquid colorant with the diluting liquid.

6. The method of spraying a liquid colorant according to claim 1, wherein water is the diluting liquid, a first surge tank receives the water from a water supply and a second surge tank with water maintained by a pump at a desired pressure provides the water into the flow path.

7. The method of spraying a liquid colorant according to claim 1, further comprising adjusting a dilution rate of the liquid colorant by controlling flow of the liquid colorant into the flow path or by controlling flow of the diluting liquid into the flow path.

8. The method of spraying a liquid colorant according to claim 1, wherein the diluting liquid is water, and a water pump in the flow path provides the water to the mixer; and a liquid colorant pump in the flow path provides liquid colorant to the mixer.

9. The method of spraying a liquid colorant according to claim 1, wherein diluting the liquid colorant improves the transfer characteristics of the liquid colorant to the uncured concrete.

10. The method of spraying a liquid colorant according to claim 1, wherein diluting the liquid colorant with water reduce cohesive properties of a binder or of a suspension agent in the liquid colorant.

11. The method of spraying a liquid colorant according to claim 1, wherein the liquid colorant is diluted to approximately 1.5 percent by weight of solids to approximately 40 percent by weight of solids.

12. The method of spraying a liquid colorant according to claim 1, the uncured concrete sprayed with the diluted liquid colorant forms concrete blocks, split face arch blocks, retaining wall units, artificial cast stone, or concrete roof tiles.

13. The method of spraying a liquid colorant according to claim 1, wherein a molding apparatus is also sprayed with the diluted liquid colorant.

14. A spray system for spraying a diluted liquid colorant on uncured concrete, comprising:
a flow path that receives a diluting liquid;
a liquid colorant pump connected to the flow path for providing liquid colorant to the flow path;
a mixer connected to the flow path, the mixer for mixing the diluting liquid with the liquid colorant; and,
a sprayer connected to the flow path, the sprayer providing diluted liquid colorant to uncured concrete.

15. The spray system according to claim 14, wherein water is the diluting liquid, a first surge tank receives the water from a water supply and a second surge tank with the water maintained by a pump at a desired pressure delivers the water to the spray system via a flow control device at the desired pressure.

16. The spray system according to claim 14, wherein the mixer comprises a static mixer.

17. The spray system according to claim 14, wherein the diluting liquid is water, and a dilution ratio is approximately 1 part liquid colorant to a range of approximately 1 part water to approximately 40 parts water.

18. The spray system according to claim 14, wherein the spray system may be adjusted by a user to different flow rates or dilution rates.

19. The spray system according to claim 14, wherein the diluting liquid is water; a water pump in the flow path provides water to the mixer; and the liquid colorant pump in the flow path provides liquid colorant to the mixer at a rate programmed by an operator.

20. The spray system according to claim 14, further comprising a microprocessor, wherein the microprocessor controls a delivery pressure of the spray system, a start/stop sequence of the spray system, or a dilution ratio of the spray system.

21. The spray system according to claim 14, wherein chemical admixtures are mixed with the diluted liquid colorant via a manifold in the flow path before the mixer.

22. The spray system according to claim 14, wherein the spray system dilutes the liquid colorant immediately prior to the diluted liquid colorant entering the sprayer.

23. The spray system according to claim 14, wherein the spray system is adjacent to a conveyor belt or other transfer means for uncured concrete.

24. The spray system according to claim 14, wherein the spray system comprises one or more different liquid colorants.

25. The spray system according to claim 14, wherein the spray system comprises a pigment tank connected to the flow path that receives the diluted liquid colorant from the mixer.

26. The spray system according to claim 14, wherein the spray system accommodates fluctuations in water flow from a water supply.

27. The spray system according to claim 14, wherein the spray system further comprises a diaphragm pump that pumps the diluting liquid at a constant pressure.

28. The spray system according to claim 14, wherein the spray system comprises a pressurized pigment tank connected to the flow path that receives the diluted liquid colorant from the mixer in batches, wherein the batches are immediately delivered to a sprayer.

29. A method of spraying a liquid colorant onto a concrete product molding apparatus, comprising:
providing a liquid colorant into a flow path;
providing a diluting liquid into the flow path;
providing a mixer connected to the flow path;
diluting the liquid colorant with the diluting liquid in the mixer;
providing a sprayer connected to the flow path; and
spraying the diluted liquid colorant onto the concrete product molding apparatus.

31. The method according to claim 29, further comprising adding uncured concrete to the molding apparatus after spraying the molding apparatus.

32. The method according to claim 29, wherein the molding apparatus receives a wet cast uncured concrete.

33. The method according to claim 29, wherein the molding apparatus further comprises division plates, the division plates are sprayed with the diluted liquid colorant, and the division plates receive a dry cast uncured concrete.
